(19) United States
(12) Patent Application Publication
(10) Pub. No.: US 2006/0016226 A1
(43) Pub. Date: Jan. 26, 2006

(54) Glass-body-heating apparatus and production method of optical fiber preform incorporaing the apparatus

(76) Inventors: Tetsuya Nakanishi, Kanagawa (JP); Masashi Onishi, Kanagawa (JP); Takashi Sasaki, Kanagawa (JP); Masaaki Hirano, Kanagawa (JP); Nobuyuki Taira, Kanagawa (JP)

Correspondence Address: MCDERMOTT WILL & EMERY LLP, 600 13TH STREET, N.W., WASHINGTON, DC, 20005-3096, US

(21) Appl. No.: 11/176,676

(22) Filed: Jul. 8, 2005

(30) Foreign Application Priority Data
Jul. 9, 2004 (JP) 2004-203741

(51) Int. Cl. C03B 37/029

(52) U.S. Cl. 65/509; 65/425; 65/426; 65/427; 65/417; 65/419

(57) ABSTRACT

An apparatus can heat a glass body with high efficiency, and a method incorporating the apparatus produces an optical fiber preform. The apparatus has (a) a heating element that has a nearly cylindrical shape and that heats a glass body inserted into the heating element and (b) an infrared reflector that is placed at a position next to each of the openings of the heating element, that surrounds the glass body together with the heating element, and that has an inner surface having a spectral emissivity of at most 0.70 in a wavelength range of 4 to 12 μm.

### BACKGROUND OF THE INVENTION

1. Field of the Invention

The present invention relates to an apparatus for heating a glass body inserted into a heating element and to a method of producing an optical fiber preform incorporating the apparatus.

2. Description of the Background Art

In the production of an optical fiber preform, a glass body is hot processed. In many cases, the glass body is a glass pipe or a glass rod both formed of silica glass. The hot processing includes a step of forming a glass layer at the inside of a glass pipe and a step of reducing the diameter of the glass pipe to achieve an intended diameter. In these steps, a heat source provided at the outside of the glass pipe heats it from one end to the other successively.

For example, in a step of forming a glass layer by the modified chemical vapor deposition (MCVD) process, while a glass material gas is introduced into the glass pipe, a heat source provided at the outside of the glass pipe is moved along the longitudinal axis of the glass pipe to heat it. This heating oxidizes the glass material gas introduced into the glass pipe to produce glass particles (SiO₂ particles). The glass particles are deposited onto the internal circumferential surface of the glass pipe at the downstream side of the flow of the glass material gas. The layer of the deposited glass particles is heated by the moving heat source to be consolidated to form a glass layer successively.

The foregoing step of forming a glass layer is repeated to form a plurality of glass layers until the intended thickness is achieved. Thus, a glass pipe to be used as an optical fiber preform can be formed. The MCVD process is suitable for the production of optical fibers having various properties, because it can adjust the refractive index of the glass layer by adding a dopant for adjusting the refractive index to the glass material gas.

The diameter-reducing step is a step prior to a step of transforming the glass pipe into a solid body by the collapsing method or the rod-in-collapsing method. In the diameter-reducing step, the glass pipe is heated from one end to the other successively to be softened, so that the diameter of the glass pipe is reduced by the surface tension.

As the heat source to be used in the hot processing of the glass body, an oxy-hydrogen burner is generally used. The flame is directed from under to upward. Consequently, as the usual way, the glass pipe is placed horizontally to be rotated around its own axis and is heated directly by the flame from under. Because the upper side of the glass pipe is not in direct contact with the flame, the temperature at the upper side of the glass pipe cannot be the same as that at the lower side of the glass pipe. Therefore, the viscosity of the glass pipe cannot be the same throughout the circumference. This condition tends to produce strain in the shape of the processed glass pipe. Furthermore, the pressure produced by the flame may shrink the softened glass pipe locally.

If the glass pipe to be used as the core of an optical fiber has a noncircular cross section, the core of the optical fiber including the rod obtained by collapsing the noncircular glass pipe also becomes noncircular. This noncircularity increases the polarization mode dispersion of the produced optical fiber, thereby degrading its transmission properties.

In addition, when the oxy-hydrogen burner is used to heat the glass body, hydroxyl groups (OH groups) produced by the oxy-hydrogen flame tend to enter the glass body. As a result, when the glass body is transformed into an optical fiber, the increment in the transmission loss due to hydroxyl groups increases.

On the other hand, the published Japanese patent application Tokukaihei 5-201740 has proposed a method in which a glass body is heated with a heating furnace having a nearly cylindrical heating.element as the heat source. In this method, the temperature of the heating element (a heater in the case of a resistance heating furnace and a susceptor in the case of an induction heating furnace) is raised either by the resistance heating or by the induction heating. A glass body is inserted into the heating element so as to be heated. This method enables the uniform heating of the glass pipe or the glass rod from the entire circumference. This uniform heating can prevent the glass body from becoming noncircular by heating and the hydroxyl groups from entering the glass body.

In the case of the oxy-hydrogen burner, the glass body is heated by the thermal conduction through the direct contact of the oxy-hydrogen flame to the glass body. In contrast, with the heating furnace, the glass body is heated mainly by the energy of the infrared rays radiated from the heating element. The efficiency of the heating by radiation increases as the emissivity (absorption coefficient) of the body to be heated increases. When silica glass is used as the body to be heated, the efficiency is low due to the low emissivity of the silica glass. As a result, the time needed to heat the glass body until the temperature reaches an intended point tends to be longer in the case of the heating furnace than in the case of the oxy-hydrogen burner.

For example, the MCVD process employing the resistance heating furnace or the induction heating furnace is required to reduce the moving speed of the heat source in comparison with the case when the oxy-hydrogen burner is employed. This slow speed increases the thickness of the glass layer deposited by one movement of the heat source, thereby making it difficult to adjust the refractive-index profile with high precision. Furthermore, air bubbles may be generated in the formed glass pipe, or mismatching in the structure of the glass pipe may result. When these drawbacks are generated, the produced optical fiber may suffer an increase in transmission loss.

### SUMMARY OF THE INVENTION

An object of the present invention is to offer an apparatus for heating a glass body with high efficiency and a method of producing an optical fiber pre-form incorporating the apparatus.

To attain the foregoing object, the present invention offers an apparatus for heating a glass body. The apparatus has:

(a) a heating element that:
(a1) has a nearly cylindrical shape; and
(a2) heats a glass body inserted into the heating element; and

(b) an infrared reflector that:
(b1) is placed at a position next to each of the openings of the heating element;
(b2) surrounds the glass body together with the heating element; and
(b3) has an inner surface having a spectral emissivity of at most 0.70 in a wavelength range of 4 to 12 μm.

According to another aspect of the present invention, the present invention offers a method of producing an optical fiber preform. The method has the step of heating a glass body by using a glass-body-heating apparatus of the present invention. Here, the types of the optical fiber preform include (a) a glass rod to be drawn in its original state to form an optical fiber, (b) a glass rod to which a cladding layer is added before the glass rod is drawn to form an optical fiber, (c) a glass pipe into which a glass rod including a portion to become a core is inserted so as to be formed as a unified structure before the glass pipe is drawn to form an optical fiber.

Advantages of the present invention will become apparent from the following detailed description, which illustrates the best mode contemplated to carry out the invention. The invention can also be carried out by different embodiments, and their details can be modified in various respects, all without departing from the invention. Accordingly, the accompanying drawing and the following description are illustrative in nature, not restrictive.

### BRIEF DESCRIPTION OF THE DRAWING

The present invention is illustrated to show examples, not to show limitations, in the figures of the accompanying drawing. In the drawing, the same reference signs and numerals refer to similar elements.

In the drawing:

FIG. 1 is a conceptual diagram showing an embodiment of an apparatus for heating a glass body according to the present invention.

FIG. 2 is an enlarged diagram showing an example of the heating furnace in a heating apparatus in the embodiment.

FIG. 3 is an enlarged diagram showing another example of the heating furnace in a heating apparatus in the embodiment.

FIG. 4 is an enlarged diagram showing yet another example of the heating furnace in a heating apparatus in the embodiment.

FIG. 5 is a conceptual diagram explaining the reduction of the diameter of a glass pipe using the heating furnace shown in FIG. 2.

### DETAILED DESCRIPTION OF THE INVENTION

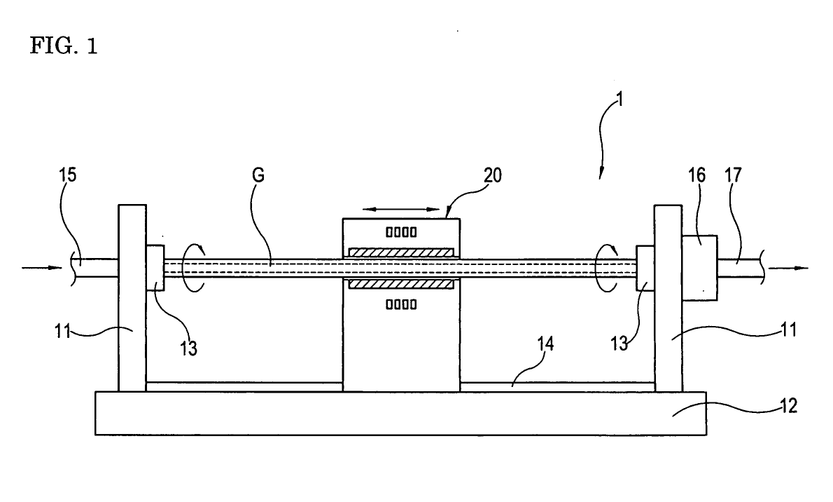

FIG. 1 is a conceptual diagram showing an embodiment of an apparatus for heating a glass body according to the present invention. A glass-body-heating apparatus 1 has a base platform 12 that is provided with standing supporters 11 in the vicinity of both ends. Each of the supporters 11 has a rotatable chuck 13 for holding the end portion of a glass pipe G so that it can be held horizontally. A heating furnace 20 for heating the glass pipe G is placed between the two supporters 11. The heating furnace 20 is, for example, an induction heating furnace or a resistance heating furnace each provided with a heating element having the shape of a circular ring to surround the glass pipe G.

The heating furnace 20 is mounted on a supporting rail 14 provided between the supporters 11 on the base platform 12, so that the heating furnace 20 can move along the longitudinal axis of the supporting rail 14. The supporting rail 14 is placed in parallel with the center axis of the glass pipe G held by the chucks 13, so that the heating furnace 20 moves in parallel with the center axis of the glass pipe G.

One of the supporters 11 at one side (left-hand side in FIG. 1) is connected with a gas-feeding pipe 15, and the other of the supporters 11 at the other side (right-hand side in FIG. 1) is connected with a buffer tank 16 and a gas-exhausting pipe 17. The gas-feeding pipe 15, the buffer tank 16, and the gas-exhausting pipe 17 together form a gas-flowing path continuous with the internal space of the glass pipe G. Although not shown in FIG. 1, the gas-feeding pipe 15 is connected with a gas-introducing means for introducing a gas into the internal space of the glass pipe G. The gas-introducing means is structured such that it can introduce silicon tetrachloride (SiCl₄), oxygen (O₂), helium (He), germanium tetrachloride (GeCl₄), and the like as a single type of gas or a properly mixed gas.

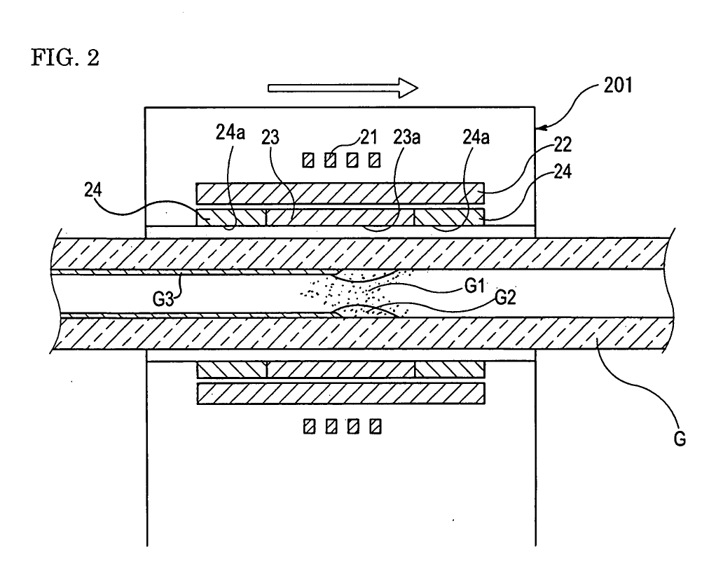

FIG. 2 is an enlarged diagram showing an example of the heating furnace in a heating apparatus in the embodiment. A heating furnace 201 is a furnace provided with a high-frequency induction heating system. When an AC current is injected into an induction coil 21, a heating element 23 generates heat. The heating element 23 has a cylindrical shape surrounding the glass pipe G and may be made of graphite (C), zirconia (ZrO₂), or the like. When the heating element 23 generates heat to raise the temperature to the glass-softening point or more, the glass pipe G is softened. When the glass pipe G is made of highly pure silica glass produced by, for example, the VAD process, the softening point is 1,700° C. or so. The induction coil 21 is arranged so as to heat the center portion of the heating element 23. The coil 21 has a properly predetermined number of turns. An insulator 22 is provided between the heating element 23 and the induction coil 21.

The heating furnace 201 is provided with an infrared reflector 24 placed at a position next to each of the openings of the heating element 23. The infrared reflector 24 has a cylindrical shape with the same diameter as that of the heating element 23 and is placed so as to surround the glass pipe G with the shape of a circular ring at each side of the heating element 23.

The infrared reflector 24 is structured such that its inner surface 24a facing the glass pipe G has a spectral emissivity of at most 0.70 in a wavelength range of 4 to 12 μm. To achieve an inner surface 24a having the foregoing spectral emissivity, the inner surface 24a can be formed of tantalum or tungsten, for example. Tantalum and tungsten have a spectral emissivity of 0.5 to 0.6 or so in a wavelength range of 4 to 12 μm. The entire infrared reflector 24 may be structured with tantalum or tungsten. An alternative design may also be employed in which only the inner surface 24a is formed of a layer of tantalum or tungsten and the other portion of the infrared reflector 24 is made of another material.

The material forming the interior of the infrared reflector 24 is required to have heat resistance at 1,000 ° C. or more considering that the inside temperature of the heating furnace 201 reaches 1,000 ° C. or more. To meet this requirement, graphite, BN, or zirconia may be used, for example. Generally, as the surface roughness decreases, the emissivity decreases. Consequently, even when the graphite is exposed at the inner surface 24a, the foregoing spectral emissivity of at most 0.70 in a range of 4 to 12 μm can be achieved by predetermining its surface roughness at a small value.

As explained above, the inner surface 24a of the infrared reflector 24 reflects the infrared rays in a wavelength range of 4 to 12 μm at a high rate. Consequently, the infrared rays in this range radiated from the heating element 23 can be contained at the inside of the heating furnace 201. As a result, the heat energy can be prevented from escaping from the openings of the heating element 23 to the outside. The wavelength range of 4 to 12 μm is a wavelength range at which the silica glass absorbs infrared rays. Therefore, when the infrared rays in this range are contained at the inside of the heating furnace 201 to be reflected toward the glass body, the glass pipe G can be heated at high efficiency. Thus, the temperature-rising speed of the glass pipe G can be increased.

The above-described method enables the hot processing of the glass body in a short heating time using a resistance heating furnace or an induction heating furnace while preventing the glass body from becoming noncircular and the hydroxyl groups from entering the glass body. In addition, because the infrared rays of a wavelength of 4 to 12 μm are prevented from escaping from the glass pipe G to the outside of the heating furnace 201, the radiation cooling of the glass pipe G can be suppressed.

Infrared rays at the short-wavelength side in the wavelength range of 4 to 12 μm, in particular, are likely to contribute to the heating of the silica glass. Therefore, it is desirable that the inner surface 24a of the infrared reflector 24 have a spectral emissivity whose value is further reduced from the value 0.70 in a wavelength range of 4 to 8 μm, more desirably in a wavelength range of 4 to 6 μm.

Furthermore, the inner surface 23a of the heating element 23 has a spectral emissivity of at least 0.80 in 30 percent or more of a wavelength range of 4 to 12 μm. As described above, the heating element 23 is made of graphite, BN, zirconia, or the like. In this case, when the graphite is exposed at the inner surface 23a, for example, the spectral emissivity of the inner surface 23a in the range of 4 to 12 μm becomes at least 0.80. In addition, the heating element 23 to be resistance-heated or induction-heated is required to be formed of an electrical conductor. Therefore, it is desirable that the inner surface 23a be formed of a layer of material having high emissivity. The following materials are examples of the high-emissivity materials having heat resistance at 1,000° C. or more to be used as the inner surface 23a: one type of graphite, BN, silicon carbide (SiC), cerium oxide (CeO₂), and terbium (Tb).

As described above, because the inner surface 23a of the heating element 23 has a spectral emissivity of at least 0.80 in 30 percent or more of the wavelength range of 4 to 12 μm, it radiates infrared rays in the range of 4 to 12 μm at high rate. This feature enables a high-efficiency transfer of the thermal energy in the wavelength range of 4 to 12 μm, at which range the silica glass exhibits a high absorption coefficient. As a result, the temperature-rising speed of the glass pipe G can be increased. As the emissivity increases, the heating efficiency increases. Therefore, it is desirable that the inner surface 23a of the heating element have a spectral emissivity of at least 0.90 in 30 percent or more of the wavelength range of 4 to 12 μm. For example, BN has a spectral emissivity of about 0.95 in 30 percent or more of the wavelength range of 4 to 12 μm.

As described above, the range for high spectral emissivity is specified to be 30 percent or more of a wavelength range of 4 to 12 μm. The reason for this is that even when the high spectral emissivity cannot be achieved in the entire range of 4 to 12 μm, the radiation of high energy can be performed.

As described above, infrared rays at the short-wavelength side in the wavelength range of 4 to 12 μm, in particular, are likely to contribute to the heating of the silica glass. Therefore, it is desirable that the inner surface 23a of the heating element 23 have a spectral emissivity whose value is further increased from the value 0.80 in a wavelength range of 4 to 8 μm, more desirably in a wavelength range of 4 to 6 μm.

It is desirable that the inner surface 23a of the heating element 23 and the inner surface 24a of the infrared reflector 24 have corrosion resistance in an environment for heating the glass pipe G. Furthermore, there is a possibility that the material of the inner surface 23a or 24a forms dust particles to enter the glass pipe G. Considering this possibility, in order to avoid degradation of the transmission property of the optical fiber produced by using the foregoing glass pipe G, for example, it is desirable that the inner surfaces 23a and 24a be made of a material that has no optical absorption property in the wavelength range of the light that is to travel over the optical fiber, such as a range of 1,260 to 1,700 nm.

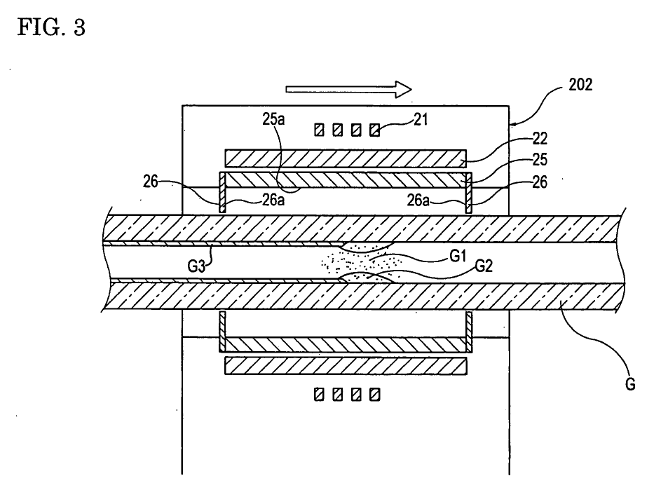

FIG. 3 is an enlarged diagram showing another example of the heating furnace in a heating apparatus in the embodiment. A heating furnace 202 is provided with an infrared reflector 26 placed at a position next to each of the openings of a cylindrical heating element 25. The infrared reflector 26 has the shape of a circular ring plate that is formed so as to shield the internal space of the heating element 25 form the outside. The infrared reflector 26 has an inner surface 26a that surrounds the glass pipe G together with the inner surface 25a of the heating element 25. The infrared reflector 26 is structured such that its inner surface 26a has a spectral emissivity of at most 0.70 in a wavelength range of 4 to 12 μm. The embodiment shown in FIG. 3 has a prominent function to contain in the inside the infrared rays that tend to escape to the outside along the center axis of the heating element 25. This function prevents the loss of the thermal energy and consequently enables an increase in the temperature-rising speed of the glass pipe G.

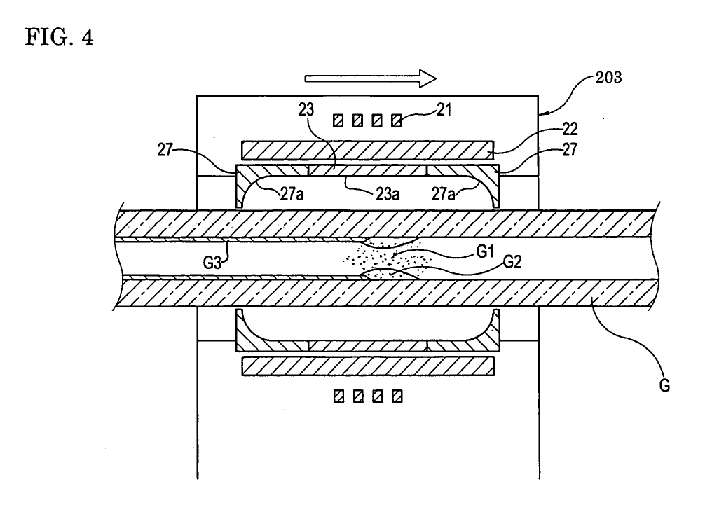

FIG. 4 is an enlarged diagram showing yet another example of the heating furnace in a heating apparatus in the embodiment. In a heating furnace 203, an inner surface 27a of an infrared reflector 27 is formed by a paraboloid whose focal point lies at the inside of a heating element 23. It is desirable that the focal point be located at the center portion of the inside of the heating element 23. The foregoing infrared reflector 27 gathers infrared rays of a wavelength of 4 to 12 μm onto the glass pipe G at the inside of the heating element 23. As a result, the efficiency of the heating can be further increased.

Next, an explanation is given on a method of producing an optical fiber preform by depositing glass particles in the glass pipe G by heating it with the glass-body-heating apparatus 1 shown in FIG. 1. The glass pipe G to be used is formed either of silica glass containing no dopant or of silica glass containing a dopant for adjusting the refractive index.

When glass particles are deposited in the glass pipe G, first, a gas-introducing means introduces a glass material gas including SiCl₄ and oxygen into the glass pipe G through the gas-feeding pipe 15. The glass material gas may include helium to adjust the partial pressure of the SiCl₄ included in it. The partial pressure of the SiCl₄ can also be adjusted by the amount of oxygen.

While the gas is introduced into the glass pipe G properly as described above, the glass pipe G is rotated around its own center axis. The rotation speed is, for example, at least 10 rpm and at most 150 rpm. The rotation speed of at least 10 rpm can decrease the temperature difference along the circumference of the glass pipe G. The rotation speed of at most 150 rpm can suppress the generation of whirling due to excessive centrifugal force.

Subsequently, the temperature of the heating element 23 is raised by injecting an electric current into the induction coil 21 such that the temperature of the inside surface of the glass pipe G reaches a temperature suitable for the MCVD process, such as a temperature of at least 1,400° C. Then, the heating furnace 20 is moved from one end of the glass pipe G to the other end along its longitudinal axis. The position for starting the movement is predetermined to be at the side at which the gas-feeding pipe 15 is placed for feeding the glass material gas.

As shown in FIGS. 2 to 4, while the glass material gas is introduced, the heating furnace 201, 202, or 203 is moved along the longitudinal axis of the glass pipe G. Under this condition, in the glass pipe G in the heated region, SiCl₄ undergoes an oxidizing reaction to produce glass particles G1. The glass particles G1 adhere onto the inside surface of the glass pipe G at the downstream side of the flow of the glass material gas by the thermophoretic effect and are deposited there. The portion where the glass particles G1 are deposited forms a porous glass-particle-deposited body G2. The glass-particle-deposited body G2 is heated by the movement of the heating furnace 201, 202, or 203 so as to be consolidated. Thus, a glass layer G3 is formed consecutively.

Because the heating furnaces 201 to 203 can heat the glass pipe G to raise its temperature at high rate, they can be moved at high speed. For example, the moving speed can be 30 mm/min or more. Moreover, the moving speed can be increased to more than 40 mm/min. The foregoing moving speed can reduce the thickness of a single glass layer deposited by a single movement. This reduced thickness facilitates the adjustment of the refractive-index profile with high precision. In addition, the distance from the position of the maximum temperature in the glass pipe G to the position at which the temperature decreases by, for example, 30° C. can be increased. Consequently, the rate of longitudinal variation in the viscosity of the glass pipe G can be decreased. Therefore, the longitudinal variation in the diameter of the glass pipe G can be suppressed. Furthermore, the generation of gas bubbles in the formed glass pipe can be prevented.

After the glass layer G3 is deposited and the heating furnace 201, 202, or 203 is moved to the gas-exhausting-pipe-17 side of the glass pipe G, the temperature of the heating furnace 201, 202, or 203 is reduced to a temperature at around which no glass particles G1 are produced in the glass pipe G, such as 500° C. when the temperature is measured at the outside surface of the glass pipe G. Then, the heating furnace 201, 202, or 203 whose temperature has been reduced is returned to the gas-feeding-pipe-15 side where the deposition of the glass soot was started. Alternatively, without the reduction of its temperature, the heating furnace 201, 202, or 203 may be returned at a high moving speed such that no glass particles G1 can be produced in the glass pipe G, such as 500 mm/min or more.

Subsequently, the above-described reciprocating movement is repeated a plurality of times to form a glass layer G3 having an intended thickness. Thus, an intended glass pipe can be formed. A glass layer G3 having an adjusted refractive index can be formed by adding a gas for adjusting the refractive index, such as GeCl₄, to the gas to be fed into the glass pipe G.

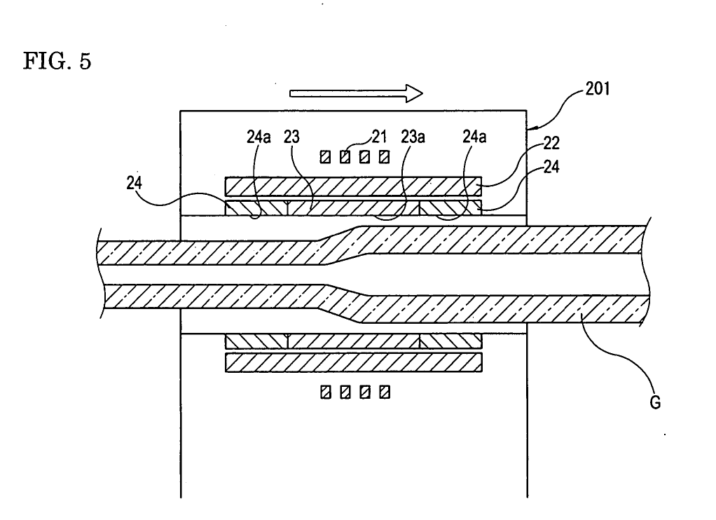

The diameter of a glass pipe can be reduced by using the glass-body-heating apparatus 1. FIG. 5 is a conceptual diagram explaining the reduction of the diameter of a glass pipe using the heating furnace 201 shown in FIG. 2. When the diameter of the glass pipe G is reduced, the heating furnace 201 or the glass pipe G or both are moved relative to each other at a comparatively high speed. Thus, a glass pipe whose shape is longitudinally stable can be obtained.

The diameter-reduced glass pipe can be collapsed by further reducing its diameter by an additional heating with the relative movement of the heating furnace 20. Rod-in-collapsing can also be performed with a similar manner. The as-collapsed glass body can be drawn to obtain an optical fiber. However, it is desirable to radially add a cladding layer to the glass body before it is drawn to obtain an optical fiber.

The glass-body-heating apparatus 1 can also be used to chemically etch the internal circumferential surface of a glass pipe by feeding a gas such as sulfur hexafluoride (SF₆) into the glass pipe. A heating furnace provided with infrared reflectors can also be used as a heat source when an optical fiber preform is drawn. In these heating steps, also, the glass-body-heating apparatus 1 can heat the glass body with high efficiency.

The present invention is described above in connection with what is presently considered to be the most practical and preferred embodiments. However, the invention is not limited to the disclosed embodiments, but, on the contrary, is intended to cover various modifications and equivalent arrangements included within the spirit and scope of the appended claims.

The entire disclosure of Japanese patent application 2004-203741 filed on Jul. 9, 2004 including the specification, claims, drawing, and summary is incorporated herein by reference in its entirety.

What is claimed is:

1. An apparatus for heating a glass body, the apparatus comprising:
(a) a heating element that:
(a1) has a nearly cylindrical shape; and
(a2) heats a glass body inserted into the heating element; and
(c) an infrared reflector that:
(b1) is placed at a position next to each of the openings of the heating element;
(b2) surrounds the glass body together with the heating element; and
(b3) has an inner surface having a spectral emissivity of at most 0.70 in a wavelength range of 4 to 12 μm.

2. An apparatus for heating a glass body as defined by claim 1, wherein the heating element has an inner surface having a spectral emissivity of at least 0.80 in 30 percent or more of a wavelength range of 4 to 12 μm.

3. An apparatus for heating a glass body as defined by claim 2, wherein the heating element has an inner surface having a spectral emissivity of at least 0.90 in 30 percent or more of a wavelength range of 4 to 12 μm.

4. An apparatus for heating a glass body as defined by claim 1, wherein the inner surface of the infrared reflector is formed by a paraboloid whose focal point lies at the inside of the heating element.

5. A method of producing an optical fiber preform, the method comprising the step of heating a glass body by using a glass-body-heating apparatus, the apparatus comprising:
(a) a heating element that:
(a1) has a nearly cylindrical shape; and
(a2) heats a glass body inserted into the heating element; and
(b) an infrared reflector that:
(b1) is placed at a position next to each of the openings of the heating element;
(b2) surrounds the glass body together with the heating element; and
(b3) has an inner surface having a spectral emissivity of at most 0.70 in a wavelength range of 4 to 12 μm.

6. A method of producing an optical fiber preform as defined by claim 5, wherein in the step of heating a glass body, the glass body is heated while at least one of the glass body and the heating element is moved relative to each other along the longitudinal axis of the glass body.
